(19) United States
(12) Patent Application Publication
(10) Pub. No.: US 2026/0319762 A1
(43) Pub. Date: Oct. 15, 2026

(54) WORKFLOW DIAGRAM FILE GENERATION

(71) Applicant: International Business Machines Corporation, Armonk, NY (US)

(72) Inventors: Alex BOUDREAUX, New Orleans, LA (US); Manisha Sri SOLIPURAM, New York, NY (US); Jesus Manuel OLIVERA, New York, NY (US); Yeun ji Jung, LONG ISLAND CITY, NY (US); Thomas GIAVATTO, Beacon, NY (US)

(21) Appl. No.: 19/176,144

(22) Filed: Apr. 10, 2025

(51) Int. Cl. G06F 8/35; G10L 15/26

(52) U.S. Cl. CPC G06F 8/35; G10L 15/26

(57) ABSTRACT

In some implementations, a computing device may generate, or receive, an ordered list of events associated with a workflow process. The ordered list of events may be based at least in part on a textual representation of the events using a tool, such as a large language model (LLM). The computing device may generate a standardized generation blueprint (SGB) based at least in part on an ordered list of events associated with a workflow process. The SGB may include a simplified code with representative terms that represent, in a simplified format, code for diagram generation. The computing device may generate code for diagram generation based at least in part on the SGB. The computing device may provide instructions for generation of a diagram that is representative of the ordered list of events associated with the workflow process.

### BACKGROUND

Workflow diagrams illustrate a process with ordered events associated with a workflow process. Workflow diagrams provide organizations with a visual representation of processes, which may be used to train members of the organization, to analyze processes for improvement, to improve approval and compliance processes, to improve efficiencies, or to conserve computing resources that may have been wasted by performing operations of the workflow process out of order or correcting errors caused by out-of-order operations.

### SUMMARY

In some implementations, a method comprises generating a standardized generation blueprint (SGB) based at least in part on an ordered list of events associated with a workflow process. The method includes generating code for diagram generation based at least in part on the SGB. The method further includes providing instructions for generation of a diagram that is representative of the ordered list of events associated with the workflow process.

In some implementations, a computer program product comprises one or more computer readable storage media and program instructions collectively stored on the one or more computer readable storage media. The program instructions comprise program instructions to extract textual input using a large language model (LLM). The program instructions comprise program instructions to generate, based at least in part on the textual input, an ordered list of events associated with a workflow process. The program instructions include program instructions to generate an SGB using the LLM based at least in part on the ordered list of events. The program instructions further comprise program instructions to generate code for diagram generation based at least in part on the SGB.

In some implementations, a system comprises one or more devices. The one or more devices are configured to generate, using an LLM, a textual representation of a workflow process. The one or more devices are configured to generate, based at least in part on the textual representation, an ordered list of events associated with the workflow process. The one or more devices are configured to generate, using the LLM and based at least in part on the ordered list of events, a simplified code associated with diagram representation of the workflow process. The one or more devices may be further configured to generate (e.g., directly or via providing instructions to an ancillary device for display), from the simplified code, full code for diagram generation based at least in part on the simplified code.

### BRIEF DESCRIPTION OF THE DRAWINGS

FIGS. 1A-1F are diagrams of an example implementation described herein.

FIG. 2 is a diagram of an example computing environment in which systems and/or methods described herein may be implemented.

FIG. 3 is a diagram of example components of one or more devices of FIGS. 1A-1F.

FIGS. 4-6 are flowcharts of example processes associated workflow diagram file generation.

### DETAILED DESCRIPTION

The following detailed description of example implementations refers to the accompanying drawings. The same reference numbers in different drawings may identify the same or similar elements.

An organization may use workflow diagrams to visually represent processes performed within the organization. The organization may use the workflow diagrams to train members of the organization, to clarify the processes, to review and improve the processes, or to share progress of the processes within the organization. Some workflow diagrams may indicate members of the organization that are involved in different operations of the process, which may be used to determine to whom a product (e.g., code) is to be sent upon completion of an operation. This may reduce production timelines, reduce errors, or conserve computing resources that may have otherwise been used to store media related to delayed processes.

A large language model (LLM) may be useful to convert natural language text into a structured format that is understandable to a computing device. For example, an LLM may use artificial intelligence or machine learning (AI/ML) tools to understand, generate, or manipulate text that is human-like (e.g., natural language). In some examples, an LLM may be build on a neural network architecture and may be trained on large datasets of text to learn patterns, grammar, context, or meaning in natural language.

However, results generated using an LLM may be unstable or inconsistent. For example, the LLM may provide a different output even if the same prompt is provided. In some cases, the difference between outputs may be significant, or may be a simple rephrasing of the same meaning. In the context of writing code that relies on precise and repeated language, an LLM may be unsuitable on its own.

A computing device may not use an LLM to generate a workflow diagram based at least in part on inconsistencies in output, errors in generating code in a format of code that is used for diagram generation, or straying from a purpose of the workflow diagram, among other examples. Manual generation of a workflow diagram may have improved consistency relative to an LLM-generated workflow diagram. However, manual generation of the workflow diagram is susceptible to human error, delay, and consumption of resources used to access, display, and review source materials.

In some aspects described herein, a computing device may perform a multi-step process for generating a workflow diagram. The computing device may use LLM to identify an ordered list of events associated with a workflow. In some examples, the computing device may use the LLM to iteratively revise the ordered list of events to reduce errors in the ordered list. The computing device may generate a simplified code (e.g., standardized generation blueprint (SGB)) that has a reduced likelihood of errors relative to code for diagram generation. In some examples, the computing device may use an LLM to generate the simplified code. The computing device may use a tool (e.g., a library or a conversion tool, among other examples) to convert the simplified code into full code. For example, the computing device may convert representative terms of the simplified code into explicit terms in the full code.

In this way, workflow diagram file generation may be automated with reduced errors relative to workflow diagram file generation where an LLM performs the entire workflow diagram file generation process. Additionally, workflow diagram file generation conserves resources associated with manual generation of workflow diagrams and error correction associated with human error.

For example, generating an accurate workflow diagram may include gathering information, analyzing the information, and iteratively revising an output to increase accuracy to identify the operations of the workflow, the order of operations of the workflow, or the personnel involved with the operations of the workflow, among other examples. The information may originate from large-scale collections of text or audio files, which may be prohibitive for manual generation of the workflow diagram based at least in part on an amount of time needed to parse through the information and generate the workflow diagram accurately before the workflow diagram becomes outdated and ready to be replaced. In implementations described herein, an LLM provides efficiency and improved latency in gathering, analyzing, and revising the information to generate output that is used in generating the workflow diagram. For example, the LLM may efficiently generate the ordered list, including iteratively revising the ordered list to improve accuracy, with resource efficiency and improved latency. Additionally, or alternatively, the LLM may efficiently generate the SGB from the ordered list with improved efficiency, latency, and accuracy. Thus, the implementations described herein have the capacity to allow organizations to generate workflow diagrams with improved accuracy, latency, and resource efficiency, which may improve effectiveness, validity, and usefulness of the workflow diagrams relative to manual generation. Additionally, or alternatively, by using LLMS to assist in the generation of the workflow diagrams, computing devices may improve scalability for generating multiple workflow diagrams within a time constraint associated with relevance of the workflow diagrams.

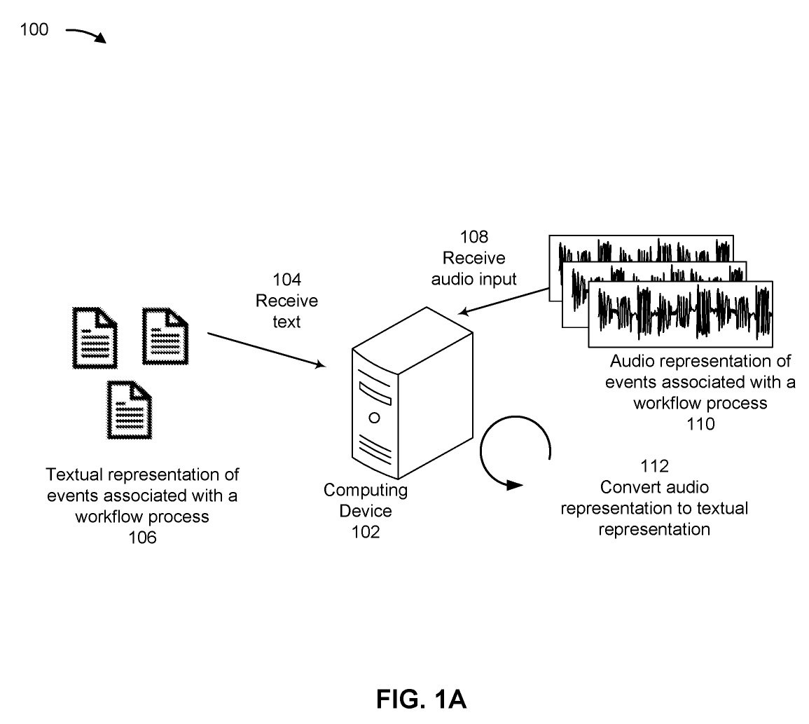

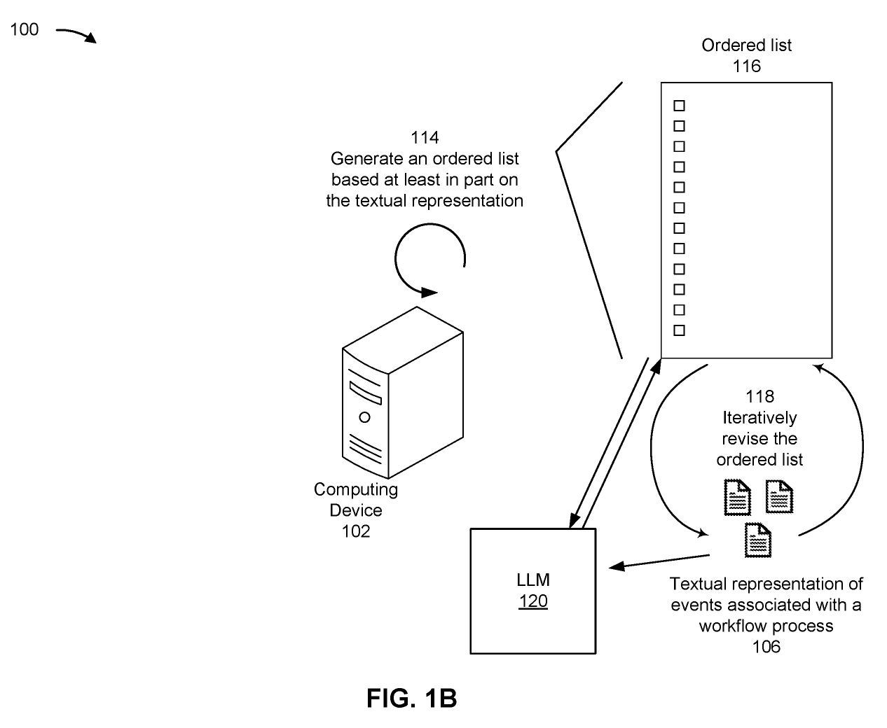

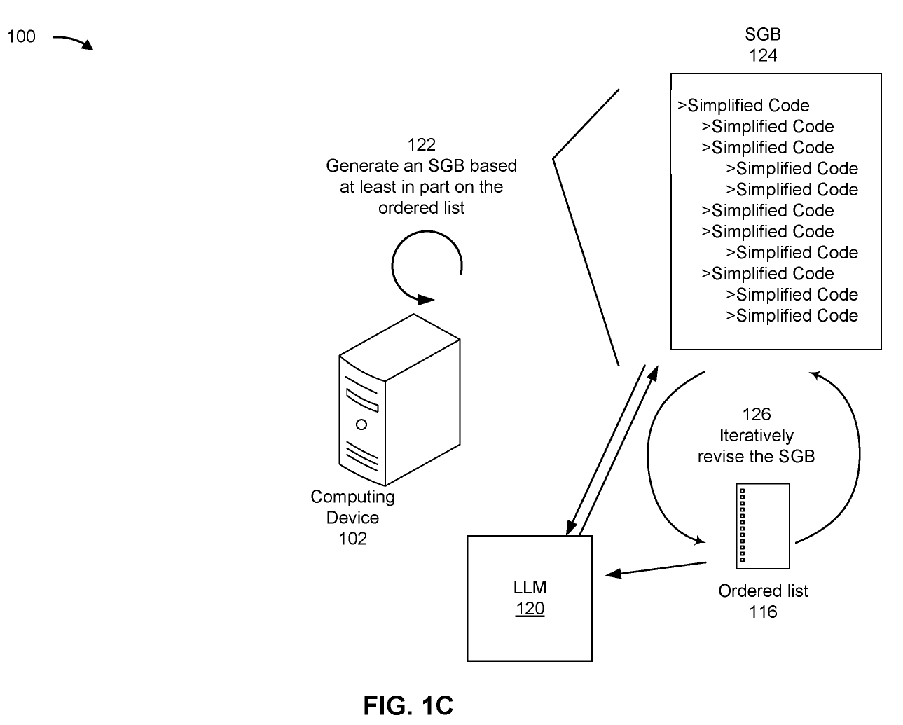

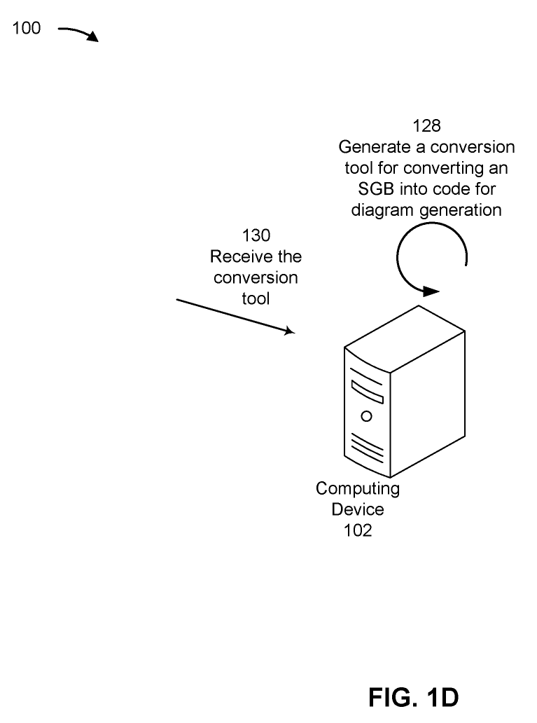

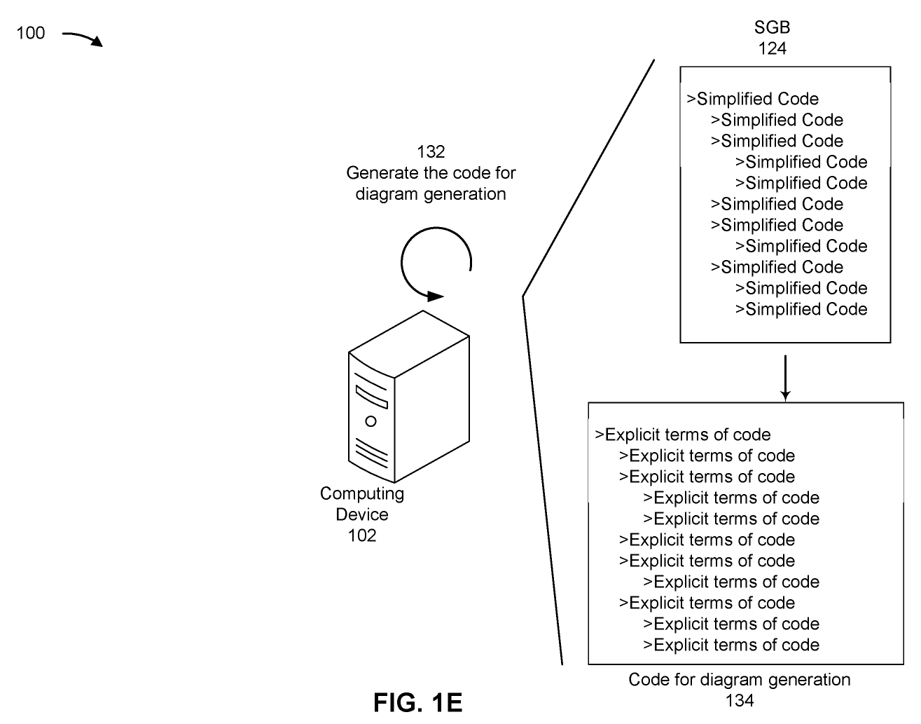

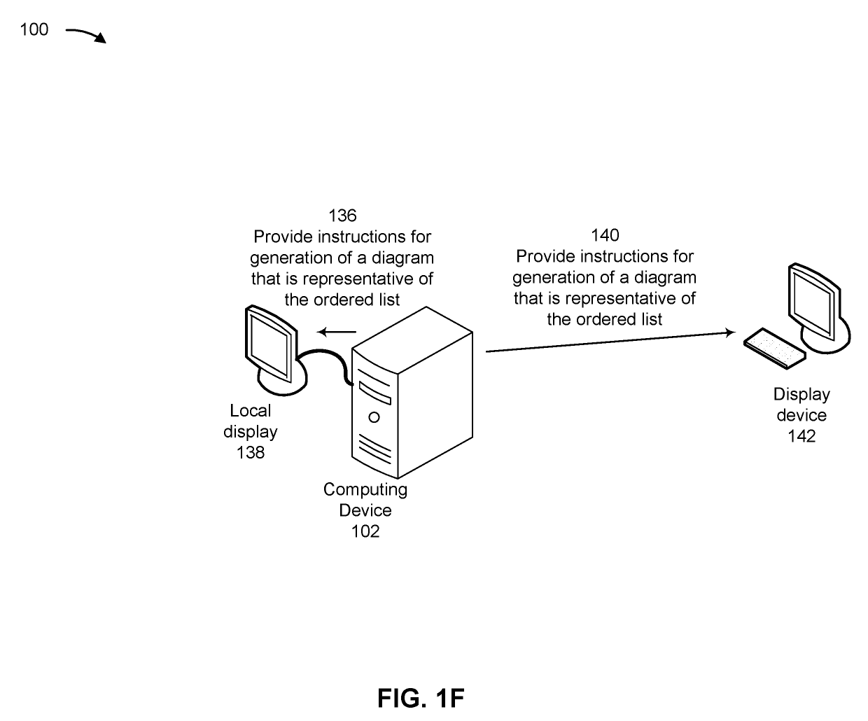

FIGS. 1A-1F are diagrams of an example implementation 100 described herein. As shown in FIGS. 1A-1F, example implementation 100 includes a framework for workflow diagram file generation that may be executed or performed by one or more computing devices (e.g., computer 201 or device 300, among other examples). Example implementation 100 describes optional operation, including alternative operations, which may be omitted in some implementations of workflow diagram file generation described herein.

As shown in FIG. 1A, a computing device 102 may receive text from one or more sources. For example, as shown by reference number 104, the computing device 102 may receive a textual representation of events associated with a workflow process 106 (referred to as “textual representation 106”). In some aspects, the textual representation 106 may include a speech-to-text transcript associated with audio input from one or more users, a natural language textual input from one or more users, a preliminary ordered list received as input from one or more users, or text from written conversations between one or more users, among other examples. For example, the textual representation 106 may include a text feed or email chain among people associated with a workflow. In some examples, the textual representation 106 may include a written description of the workflow provided by a user.

As shown by reference number 108, the computing device 102 may receive audio input. The audio input may include an audio representation of events associated with the workflow process 110 (“audio representation 110”). For example, the audio representation 110 may include an audio description of the workflow process or a recording of one or more calls between one or more users associated with the workflow. As shown by reference number 112, the computing device 102 may convert the audio representation 110 to a text representation. For example, the computing device 102 may use a speech-to-text application or model to generate a transcript as the textual representation associated with the audio input and audio representation 110.

In the context of FIG. 1A, the computing device 102 may receive the textual representation 106 or may generate the textual representation based at least in part on receiving audio input and converting the audio representation 110 to the textual representation. In some aspects, the computing device may use both text received from another computing device and audio input. In other examples, the computing device 102 may either receive textual representation 106 from another computing device or input device, or receive audio input and generate the textual representation, among other examples.

As shown in FIG. 1B, and by reference number 114, the computing device 102 may generate an ordered list based at least in part on the textual representation 106 (e.g., received or generated using audio input). In some aspects, the computing device 102 may generate an ordered list 116 of events associated with the workflow process. As further shown in FIG. 1B, in some aspects, the computing device 102 may use an LLM 120 to generate the ordered list 116 from the textual representation 108. For example, the LLM 120 may use the textual representation 108 as input and may organize events described in the textual representation 108 into the ordered list 116.

As shown by reference number 118, the computing device 102 may iteratively revise the ordered list 116 based at least in part on comparing the ordered list 116 with the textual representation 106. In some aspects, the LLM 120 may be used as an agent to revise or verify that the textual description 106 as input data is consistent with the ordered list 116 (e.g., an LLM-generated ordered list). The computing device 102 may use the LLM 120 as an agent to iteratively compare and update the ordered list 116 until the textual description 106 (e.g., input data to the LLM) and the ordered list 116 (output data) are consistent. For example, the LLM 120 may iteratively compare a current version of the ordered list 116 to the textual representation 106 and modify the current version of the ordered list 116 based at least in part on the comparison.

As shown in FIG. 1C, and by reference number 122, the computing device 102 may generate a standardized generation blueprint (SGB) 124 or other simplified code based at least in part on the ordered list 116. In some aspects, the computing device 102 may generate the SGB 124 that includes representative terms that represent, in a simplified format, code for diagram generation. For example, the simplified code may represent a wholistic description of what a full code for diagram generation will be. The simplified code (e.g., SGB 124) may be understandable because of representative call outs of operations, values, or indicators, but may not be suitable to generate an image or diagram. In some aspects, the simplified code could be in a format, such as XML or JSON, among other examples. The simplified code may be referred to as an intermediate code configured to be converted to code for diagram generation (e.g., a complete, correctly-formed, industry standard diagram file, among other examples). In some aspects, the simplified code is configured such that generation of the simplified code from the ordered list 116 using the LLM 120 is expected to have fewer errors than generation of full code for diagram generation from the ordered list 116 using the LLM 120.

As further shown in FIG. 1C, in some aspects, the computing device 102 may use the LLM 120 (e.g., the same LLM 120 as described in connection with FIG. 1B or a different LLM) to generate the SGB 124 from the ordered list 116. For example, the LLM 120 may use the textual representation 108 or ordered list 116 as input and may generate the SGB 124 as a wholistic code description of the events described in the textual representation 108 or the ordered list 116.

As shown by reference number 126, the computing device 102 may iteratively revise the SGB 124 based at least in part on comparing the SGB 124 with the ordered list 116. In some aspects, the LLM 120 may be used as an agent to revise or verify that the SGB 124 as output data is consistent with the ordered list 116. The computing device 102 may use the LLM 120 as an agent to iteratively compare and update the SGB 124 until the ordered list 116 (e.g., input data to the LLM) and the SGB 124 (output data) are consistent. For example, the LLM 120 may iteratively compare a current version of the SGB 124 to the ordered list 116 and modify the current version of the SGB 124 based at least in part on the comparison.

As shown in FIG. 1D, and by reference number 128, the computing device 102 may generate a conversion tool for converting an SGB file into code for diagram generation. In some aspects, the computing device 102 may create a library of linked terms, operations, or identifiers, among other examples, that can be used to convert elements of code in the SGB file to code for diagram generation. As shown by reference number 130, the computing device 102 may receive the conversion tool from another computing device. For example, the conversion tool may be standardized for use across multiple computing devices.

As shown in FIG. 1E, and by reference number 132, the computing device 102 may generate the code for diagram generation. In some aspects, the computing device 102 may use the conversion tool to convert the SGB 124 from simplified code to the code for diagram generation 134 (“code 134”) that includes explicit terms of code that are associated with diagram or image generation. The SGB 124 may be an input to the conversion tool and the code 134 may be an output as a complete process diagram file. The code 134 may include a fully-formed, syntactically correct diagram file.

As shown in FIG. 1F, and by reference number 136, the computing device 102 may provide instructions for generation of a diagram that is representative of the ordered list 116 (and the textual representation 106) to a local display 138 for rendering. In some aspects, the instructions may include the code 134 for image generation or a derivative thereof that is understandable by a computing component of the local display 138.

As shown by reference number 134, the computing device 102 may, additionally or alternatively, provide the instructions for generation of the diagram that is representative of the ordered list 116 to a display device 142 that is not a local display. For example, the computing device may include a network device (e.g., a server) that generates the code 134 and provides the code 134, or a derivative thereof, to user devices for viewing the diagram.

Based at least in part on operations described in connection with FIGS. 1A-1F, workflow diagram file generation may be automated. The workflow diagram may have reduced errors relative to workflow diagram file generation where an LLM performs the entire workflow diagram file generation process. Additionally, the operations describe workflow diagram file generation that conserves resources associated with manual generation of workflow diagrams and error correction associated with human error.

As indicated above, FIGS. 1A-1F are provided as an example. Other examples may differ from what is described with regard to FIGS. 1A-1F. For example, the one or more devices or operations described in connection with FIGS. 1A-1F may be omitted or used in the alternative with other devices or operations.

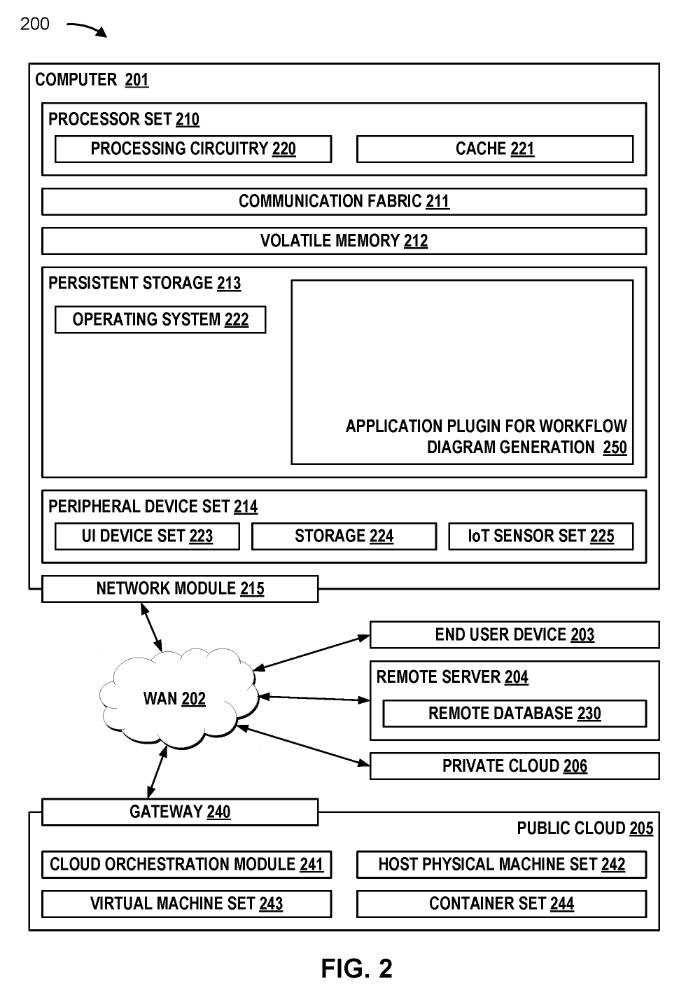

FIG. 2 is a diagram of an example computing environment 200 in which systems and/or methods described herein may be implemented. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 200 contains an example of an environment for the execution of at least some of the computer code involved in performing the inventive methods, such as application plugin for workflow diagram file generation 250. In addition to application plugin for workflow diagram file generation 250, computing environment 200 includes, for example, computer 201, wide area network (WAN) 202, end user device (EUD) 203, remote server 204, public cloud 205, and private cloud 206. In this embodiment, computer 201 includes processor set 210 (including processing circuitry 220 and cache 221), communication fabric 211, volatile memory 212, persistent storage 213 (including operating system 222 and application plugin for workflow diagram file generation 250, as identified above), peripheral device set 214 (including user interface (UI) device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244.

Computer 201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

Processor set 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 200, at least some of the instructions for performing the inventive methods may be stored in application plugin for workflow diagram file generation 250 in persistent storage 213.

Communication fabric 211 is the signal conduction path that allows the various components of computer 201 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, volatile memory 212 is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

Persistent storage 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid state storage devices. Operating system 222 may take several forms, such as various known proprietary operating systems or open source Portable Operating System Interface-type operating systems that employ a kernel. The code included in application plugin for workflow diagram file generation 250 typically includes at least some of the computer code involved in performing the inventive methods.

Peripheral device set 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

Network module 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215.

WAN 202 is any wide area network (for example, the internet) capable of communicating computer data over non-local distances by any technology for communicating computer data, now known or to be developed in the future. In some embodiments, the WAN 202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 203 is any computer system that is used and controlled by an end user (for example, a customer of an enterprise that operates computer 201) and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

Remote server 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

Public cloud 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

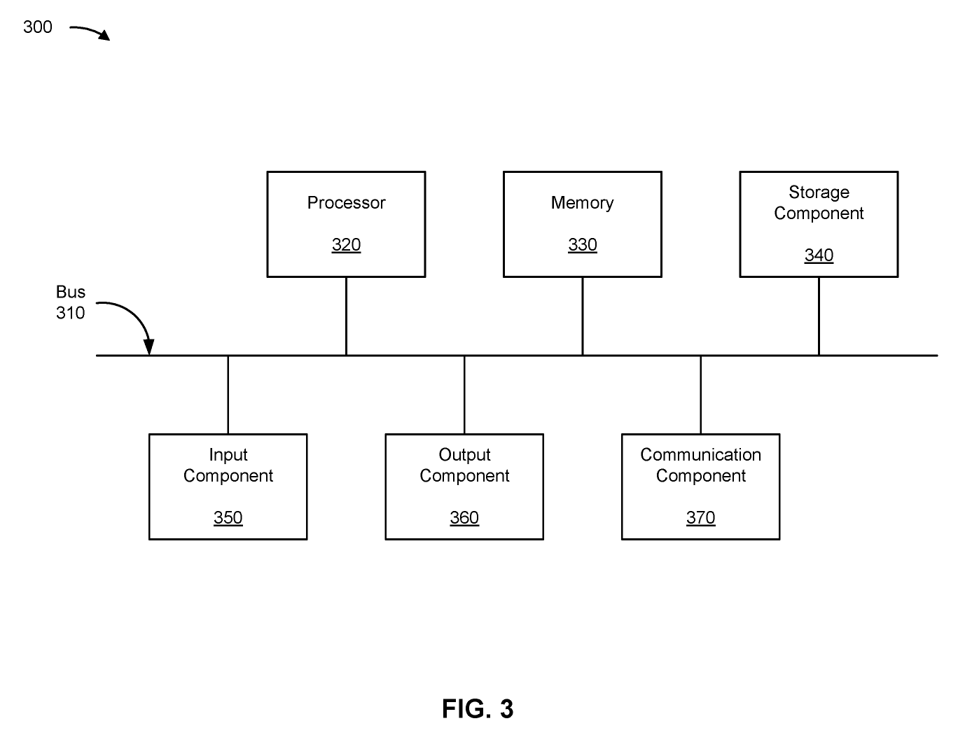

FIG. 3 is a diagram of example components of a device 300, which may correspond to the computing computer 201, among other examples, that performs agent workflow operations. In some implementations, the computer 201 may include one or more devices 300 and/or one or more components of device 300. As shown in FIG. 3, device 300 may include a bus 310, a processor 320, a memory 330, a storage component 340, an input component 350, an output component 360, and a communication component 370.

Bus 310 includes a component that enables wired and/or wireless communication among the components of device 300. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform a function. Memory 330 includes a random access memory, a read only memory, and/or another type of memory (e.g., a flash memory, a magnetic memory, and/or an optical memory).

Storage component 340 stores information and/or software related to the operation of device 300. For example, storage component 340 may include a hard disk drive, a magnetic disk drive, an optical disk drive, a solid state disk drive, a compact disc, a digital versatile disc, and/or another type of non-transitory computer-readable medium. Input component 350 enables device 300 to receive input, such as user input and/or sensed inputs. For example, input component 350 may include a touch screen, a keyboard, a keypad, a mouse, a button, a microphone, a switch, a sensor, a global positioning system component, an accelerometer, a gyroscope, and/or an actuator. Output component 360 enables device 300 to provide output, such as via a display, a speaker, and/or one or more light-emitting diodes. Communication component 370 enables device 300 to communicate with other devices, such as via a wired connection and/or a wireless connection. For example, communication component 370 may include a receiver, a transmitter, a transceiver, a modem, a network interface card, and/or an antenna.

Device 300 may perform one or more processes described herein. For example, a non-transitory computer-readable medium (e.g., memory 330 and/or storage component 340) may be a repository that stores a set of instructions (e.g., one or more instructions, code, software code, and/or program code) for execution by processor 320. Processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

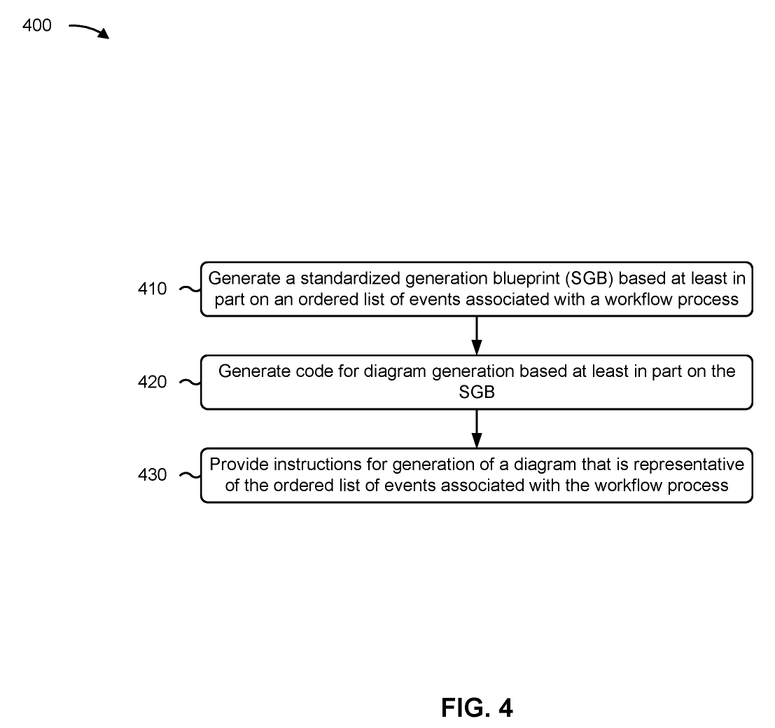

FIG. 4 is a flowchart of an example process 400 associated with workflow diagram file generation. In some implementations, one or more process blocks of FIG. 4 may be performed by one or more computing devices (e.g., computer 201). In some implementations, one or more process blocks of FIG. 4 may be performed by another device or a group of devices separate from or including the computing device, such as a network computing device, an application server, or a personal computing device. Additionally, or alternatively, one or more process blocks of FIG. 4 may be performed by one or more components of device 300, such as processor 320, memory 330, storage component 340, input component 350, output component 360, and/or communication component 370.

As shown in FIG. 4, process 400 may include generating a standardized generation blueprint (SGB) based at least in part on an ordered list of events associated with a workflow process (block 410). For example, the computing device may generate a standardized generation blueprint (SGB) based at least in part on an ordered list of events associated with a workflow process, as described above.

As further shown in FIG. 4, process 400 may include generating code for diagram generation based at least in part on the SGB (block 420). For example, the computing device may generate code for diagram generation based at least in part on the SGB, as described above.

As further shown in FIG. 4, process 400 may include providing instructions for generation of a diagram that is representative of the ordered list of events associated with the workflow process (block 430). For example, the computing device may provide instructions for generation of a diagram that is representative of the ordered list of events associated with the workflow process, as described above.

Process 400 may include additional implementations, such as any single implementation or any combination of implementations described below and/or in connection with one or more other processes described elsewhere herein.

In a first implementation, process 400 includes applying a large language model (LLM) to generate the ordered list of events from a textual representation of the events.

In a second implementation, alone or in combination with the first implementation, the textual representation of the events comprises one or more of a speech-to-text transcript associated with audio input from one or more users, a natural language textual input from one or more users, a preliminary ordered list received as input from one or more users, or from written conversations between one or more users.

In a third implementation, alone or in combination with one or more of the first and second implementations, process 400 includes iteratively revising the ordered list using an LLM.

In a fourth implementation, alone or in combination with one or more of the first through third implementations, iteratively revising the ordered list using the LLM comprises iteratively comparing a current version of the ordered list to a textual representation of the events, and modifying the current version of the ordered list based at least in part on the comparing.

In a fifth implementation, alone or in combination with one or more of the first through fourth implementations, process 400 includes iteratively revising the SGB using an LLM.

In a sixth implementation, alone or in combination with one or more of the first through fifth implementations, iteratively revising the SGB using the LLM comprises iteratively comparing a current version of the SGB to the ordered list of events or a textual representation of the events, and modifying the current version of the SGB based at least in part on the comparing.

In a seventh implementation, alone or in combination with one or more of the first through sixth implementations, the SGB comprises representative terms that represent, in a simplified format, the code for diagram generation.

In an eighth implementation, alone or in combination with one or more of the first through seventh implementations, generating the code for diagram generation is based at least in part on the SGB comprises applying a tool to convert representative terms of the SGB to explicit terms associated with the code for diagram generation.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

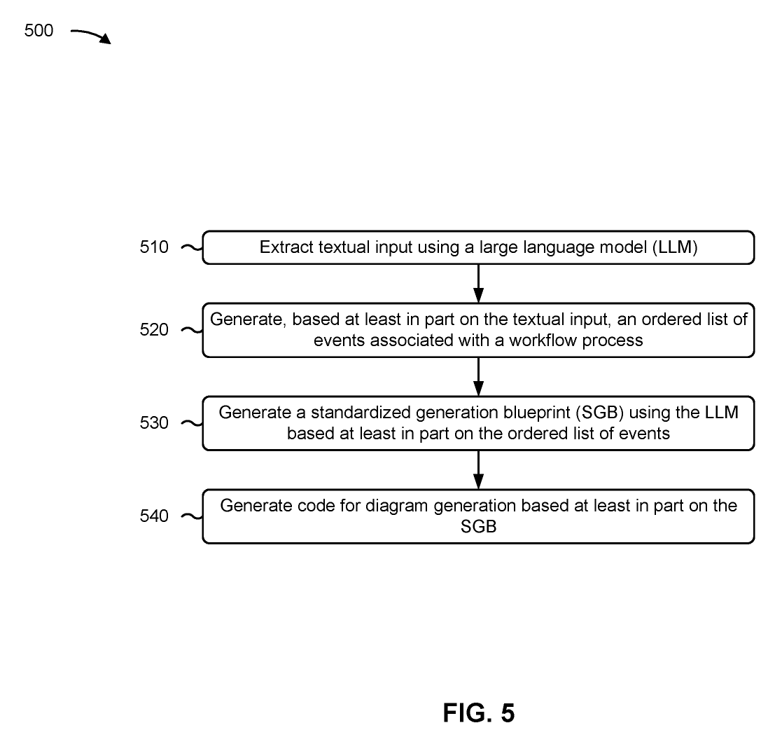

FIG. 5 is a flowchart of an example process 500 associated with workflow diagram file generation. In some implementations, one or more process blocks of FIG. 5 may be performed by one or more computing devices (e.g., computer 201). In some implementations, one or more process blocks of FIG. 5 may be performed by another device or a group of devices separate from or including the computing device, such as a network computing device, an application server, or a personal computing device. Additionally, or alternatively, one or more process blocks of FIG. 5 may be performed by one or more components of device 300, such as processor 320, memory 330, storage component 340, input component 350, output component 360, and/or communication component 370.

As shown in FIG. 5, process 500 may include extracting textual input using an LLM (block 510). For example, the computing device may extract textual input using an LLM, as described above.

As further shown in FIG. 5, process 500 may include generating, based at least in part on the textual input, an ordered list of events associated with a workflow process (block 520). For example, the computing device may generate, based at least in part on the textual input, an ordered list of events associated with a workflow process, as described above.

As further shown in FIG. 5, process 500 may include generating an SGB using the LLM based at least in part on the ordered list of events (block 530). For example, the computing device may generate an SGB using the LLM based at least in part on the ordered list of events, as described above.

As further shown in FIG. 5, process 500 may include generating code for diagram generation based at least in part on the SGB (block 540). For example, the computing device may generate code for diagram generation based at least in part on the SGB, as described above.

Process 500 may include additional implementations, such as any single implementation or any combination of implementations described below and/or in connection with one or more other processes described elsewhere herein.

In a first implementation, process 500 includes generating a diagram that is representative of the ordered list of events.

In a second implementation, alone or in combination with the first implementation, generating the SGB using the LLM comprises using the LLM to iteratively compare a current version of the SGB to the ordered list of events or a textual representation of the events, and modifying the current version of the SGB based at least in part on the comparison.

In a third implementation, alone or in combination with one or more of the first and second implementations, generating the ordered list of events comprises using the LLM to iteratively compare a current version of the ordered list of events to the textual input, and modifying the current version of the ordered list of events based at least in part on the comparison.

In a fourth implementation, alone or in combination with one or more of the first through third implementations, the textual input comprises one or more of a speech-to-text transcript associated with audio input from one or more users, a natural language textual input from one or more users, a preliminary ordered list received as input from one or more users, or from written conversations between one or more users.

In a fifth implementation, alone or in combination with one or more of the first through fourth implementations, the SGB comprises representative terms that represent, in a simplified format, the code for diagram generation.

In a sixth implementation, alone or in combination with one or more of the first through fifth implementations, generating the code for diagram generation comprises converting representative terms of the SGB to explicit terms associated with the code for diagram generation.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

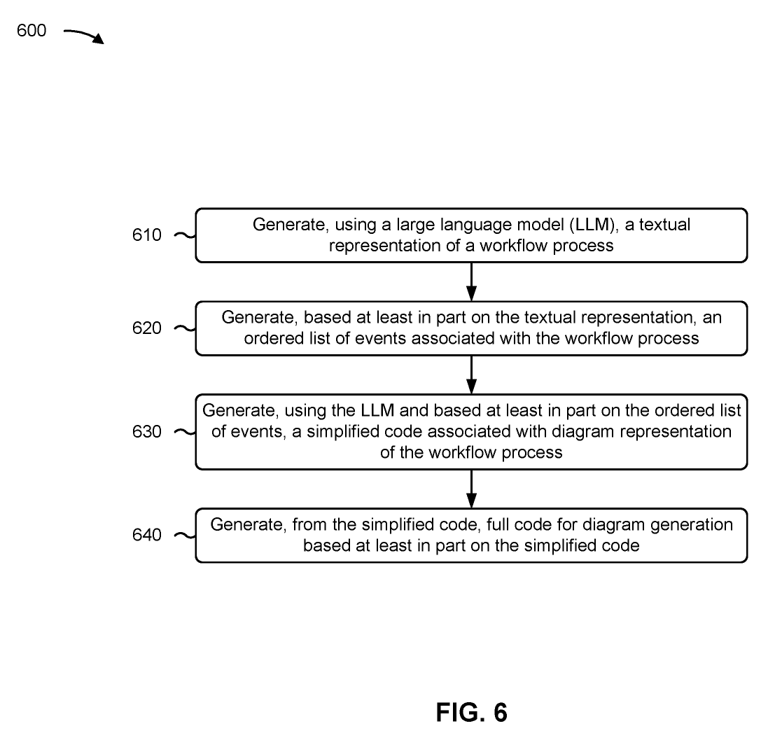

FIG. 6 is a flowchart of an example process 600 associated with workflow diagram file generation. In some implementations, one or more process blocks of FIG. 6 may be performed by one or more computing devices (e.g., computer 201). In some implementations, one or more process blocks of FIG. 6 may be performed by another device or a group of devices separate from or including the computing device, such as a network computing device, an application server, or a personal computing device. Additionally, or alternatively, one or more process blocks of FIG. 6 may be performed by one or more components of device 300, such as processor 320, memory 330, storage component 340, input component 350, output component 360, and/or communication component 370.

As shown in FIG. 6, process 600 may include generating, using an LLM, a textual representation of a workflow process (block 610). For example, the computing device may generate, using an LLM, a textual representation of a workflow process, as described above.

As further shown in FIG. 6, process 600 may include generating, based at least in part on the textual representation, an ordered list of events associated with the workflow process (block 620). For example, the computing device may generate, based at least in part on the textual representation, an ordered list of events associated with the workflow process, as described above.

As further shown in FIG. 6, process 600 may include generating, using the LLM and based at least in part on the ordered list of events, a simplified code associated with diagram representation of the workflow process (block 630). For example, the computing device may generate, using the LLM and based at least in part on the ordered list of events, a simplified code associated with diagram representation of the workflow process, as described above.

As further shown in FIG. 6, process 600 may include generating, from the simplified code, full code for diagram generation based at least in part on the simplified code (block 640). For example, the computing device may generate, from the simplified code, full code for diagram generation based at least in part on the simplified code, as described above.

Process 600 may include additional implementations, such as any single implementation or any combination of implementations described below and/or in connection with one or more other processes described elsewhere herein.

In a first implementation, process 600 includes receiving a speech-to-text transcript of associated with audio input from one or more users, or generating a speech-to-text transcript of associated with audio input from one or more users, wherein generating the textual representation of the workflow process comprises using the LLM to generate the textual representation based at least in part on the speech-to-text transcript.

In a second implementation, alone or in combination with the first implementation, generating the full code from the simplified code comprises converting representative terms of the simplified code to explicit terms associated with the full code.

In a third implementation, alone or in combination with one or more of the first and second implementations, the simplified code is configured such that generation of the simplified code from the ordered list of events using the LLM is expected to have fewer errors than generation of the full code from the ordered list of events using the LLM.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

In addition to the implementations described above, elements described in connection with any of processes 400, 500, or 600 may be combined with elements of another of processes 400, 500, or 600.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
generating a standardized generation blueprint (SGB) based at least in part on an ordered list of events associated with a workflow process;
generating code for diagram generation based at least in part on the SGB; and
providing instructions for generation of a diagram that is representative of the ordered list of events associated with the workflow process.

2. The method of claim 1, further comprising:
applying a large language model (LLM) to generate the ordered list of events from a textual representation of the events.

3. The method of claim 2, wherein the textual representation of the events comprises one or more of:
a speech-to-text transcript associated with audio input from one or more users,
a natural language textual input from one or more users,
a preliminary ordered list received as input from one or more users, or
text from written conversations between one or more users.

4. The method of claim 1, further comprising:
iteratively revising the ordered list using a large language model (LLM).

5. The method of claim 4, wherein iteratively revising the ordered list using the LLM comprises:
iteratively comparing a current version of the ordered list to a textual representation of the events; and
modifying the current version of the ordered list based at least in part on the comparing.

6. The method of claim 1, further comprising:
iteratively revising the SGB using a large language model (LLM).

7. The method of claim 6, wherein iteratively revising the SGB using the LLM comprises:
iteratively comparing a current version of the SGB to the ordered list of events or a textual representation of the events; and
modifying the current version of the SGB based at least in part on the comparing.

8. The method of claim 1, wherein the SGB comprises representative terms that represent, in a simplified format, the code for diagram generation.

9. The method of claim 1, wherein generating the code for diagram generation is based at least in part on the SGB comprises:
applying a tool to convert representative terms of the SGB to explicit terms associated with the code for diagram generation.

10. A computer program product comprising:
one or more computer readable storage media, and program instructions collectively stored on the one or more computer readable storage media, the program instructions comprising:
program instructions to extract textual input using a large language model (LLM);
program instructions to generate, based at least in part on the textual input, an ordered list of events associated with a workflow process;
program instructions to generate a standardized generation blueprint (SGB) using the LLM based at least in part on the ordered list of events; and
program instructions to generate code for diagram generation based at least in part on the SGB.

11. The computer program product of claim 10, wherein the program instructions further comprise:
program instructions to generate a diagram that is representative of the ordered list of events.

12. The computer program product of claim 10, wherein, to generate the SGB using the LLM, the program instructions further comprise:
program instructions to use the LLM to iteratively compare a current version of the SGB to the ordered list of events or a textual representation of the events; and
program instructions to modify the current version of the SGB based at least in part on the comparison.

13. The computer program product of claim 10, wherein, to generate the ordered list of events, the program instructions further comprise:
program instructions to use the LLM to iteratively compare a current version of the ordered list of events to the textual input; and
program instructions to modify the current version of the ordered list of events based at least in part on the comparison.

14. The computer program product of claim 10, wherein the textual input comprises one or more of:
a speech-to-text transcript associated with audio input from one or more users,
a natural language textual input from one or more users,
a preliminary ordered list received as input from one or more users, or
text from written conversations between one or more users.

15. The computer program product of claim 10, wherein the SGB comprises representative terms that represent, in a simplified format, the code for diagram generation.

16. The computer program product of claim 10, wherein, to generate the code for diagram generation, the program instructions comprise:
program instructions to convert representative terms of the SGB to explicit terms associated with the code for diagram generation.

17. A system comprising:
one or more devices configured to:
generate, using a large language model (LLM), a textual representation of a workflow process;
generate, based at least in part on the textual representation, an ordered list of events associated with the workflow process;
generate, using the LLM and based at least in part on the ordered list of events, a simplified code associated with diagram representation of the workflow process; and
generate, from the simplified code, full code for diagram generation based at least in part on the simplified code.

18. The system of claim 17, wherein the one or more devices are configured to:
receive a speech-to-text transcript of associated with audio input from one or more users, or
generate a speech-to-text transcript of associated with audio input from one or more users,
wherein, to generate the textual representation of the workflow process, the one or more devices are configured to use the LLM to generate the textual representation based at least in part on the speech-to-text transcript.

19. The system of claim 17, wherein, to generate the full code from the simplified code, the one or more devices are configured to:
convert representative terms of the simplified code to explicit terms associated with the full code.

20. The system of claim 17, wherein the simplified code is configured such that generation of the simplified code from the ordered list of events using the LLM is expected to have fewer errors than generation of the full code from the ordered list of events using the LLM.
